(19) United States
(12) Patent Application Publication
(10) Pub. No.: US 2007/0265965 A1
(43) Pub. Date: Nov. 15, 2007

(54) Real-time status and event monitoring system for foster children with various user levels of access

(75) Inventor: David Springett, Sacramento, CA (US)

Correspondence Address: MATHEW J. TEMMERMAN, 423 E. STREET, DAVIS, CA, 95616, US

(73) Assignee: Community College Foundation

(21) Appl. No.: 11/803,743

(22) Filed: May 15, 2007

Related U.S. Application Data
(60) Provisional application No. 60/800,722, filed on May 15, 2006.

(51) Int. Cl. H04L 9/00

(52) U.S. Cl. 705/50

(57) ABSTRACT

A system used for the record keeping and tracking of data related to foster youth. The system includes an encrypted portable smart card containing critical foster youth data, a means for accessing and updated the foster youth data in real time either through the smart card or over the Internet. The data tracked and monitored can include data from various agencies and organizations, and includes data such as among other immunization history, emergency medical, basic medical history, allergies, educational records, individual, educational plans, dental history, insurance information, services available and/or provided, demographic detail, care provider, and a current photo of the individual. Data is stored in a tangible, portable and secure format, the records travel with the youth from service provider to service provider—continuously being updated. Information can be shared electronically from one database to another—while protecting the integrity of each system, and accessed via users through their own encrypted smart cards.

### RELATED APPLICATIONS

This application is based on provisional application 60/800,722 filed 15 May 2006.

### FIELD OF THE INVENTION

This invention relates to collection, storage, displaying, and updating of medical records, educations records, data and other life events for foster youth.

### BACKGROUND OF THE INVENTION

There are approximately 588,000 children in foster care and over 133,000 foster families caring for this vulnerable population. Many foster youth are in the foster care system due to abuse, neglect and lack of a stable home life. Hence, many of these children have complex physical health, behavioral health, and developmental needs. These troubled youth generally need a temporary home with caring individuals that can give them the time and nurturing environment they need to grow and thrive. Foster care agencies and organizations that place children in foster care work together to meet the many needs of the youth in care, but even still, any children placed in foster care for any reason face challenges that most children do not experience. Adapting to a new environment can be difficult for children, and they may feel any mix of emotions while they are adjusting to their new homes. The goal is to achieve permanency for the child by having the youth return to their birth family when possible, to live independently as an adult or to be adopted.

Associated with each child in foster care are a plethora of records. The recordkeeping of information regarding America's foster youth has in general been inefficient and plagued with problems. Foster youth records are incomplete, lost, or disbursed among various governmental and other agencies and organizations that serve our nation's foster children. Furthermore, an estimated $1.5 billion is spent annually on duplicative services for foster children. The problem stems from the fact that foster youth move an average of three times annually, and records do not follow at the same pace. Oftentimes, children move from one county or state to another, and there is no one universal means for maintaining records from jurisdiction to jurisdiction.

Moving from school to school and home to home is hard enough on foster youth, and this transition is made more difficult when the youths' records fail to move with the children. Making new friends and fitting in at each new home is a task in and of itself, but when foster youth are kept out of school because their immunization records fail to follow them, the students sometimes fall behind other children, which can potentially alienate them from their peers. A conservative estimate is that a majority of foster youth are out of school 40 days per year.

Incomplete records also result in over-immunization, critical health information not being kept up-to-date, poor follow-up levels for health conditions normally requiring a follow-up evaluation, and missed opportunities to address educational needs. The lack of records following our foster youth occurs even though there have been several legislative attempts to require states and counties to maintain these essential foster youth records. Currently, no child centered data systems are available that link foster youth to their health and education records as they move through the system.

There is thus a need for a comprehensive, cost-effective and dynamic data acquisition, storage and retrieval system to meet the medical, educational, behavioral and life needs of foster children.

### SUMMARY OF THE INVENTION

To solve the above problems, the Applicant proposes a real-time status and event monitoring system for the secure portable Internet-based health and education data tracking of foster youth delivered via equipment comprising a database and smart card. The Applicant's system simultaneously updates and manages critical youth information and records in a real-time format through a secure synchronization technology. Youth data from multiple database systems may be securely exchanged through a data exchange server that allows updates at any time. Through the above means, the Applicant's system empowers youths, state and local agencies, schools, medical provides, foster and adoptive parents by providing a secure, convenient way to store the youths' personal records in a portable electronic form.

Benefits of the Applicant's system include the prevention of over-immunization, medication interactions and misdiagnosis. With regard to education, the system reduces delays in school enrollment by providing complete accessible documentation for enrolling in school. This same documentation reduces delays in applying for work, receiving medical care and completing emancipation. The system reduces duplicate efforts from one government jurisdiction or agency to the next, and provides consistent information across organizational boundaries.

While maintaining the records is important, maintaining a high level of security surrounding access to the records is equally important, and is provided for by the Applicant's system. Records are made available to the appropriate governmental entities on an as needed basis. Various levels of access are granted to users of the system wherein the higher the level of access granted, the more details regarding the status of youth and data regarding events surrounding the youth may be viewed and/or modified.

The Applicant's system can be implemented either on a local, statewide, or federal basis. Statewide implementation is the preferred embodiment of the system because of the number of youth transferring between foster homes and local communities and the number of state records normally kept in relation to this. Through a statewide implementation, the data and records surrounding the child will remain with the child even if the child relocates. National implementation is possible using the Applicant's system as well. The system is preferably implemented by the agency (usually Children's Services) that holds custody of the foster youth. This ensures that when information about the foster youth is shared between those agencies, and with organizations and individuals involved in the youths' lives that permission to share such information is granted, that releases of information are signed and that memorandums of understanding are in place.

The system is implemented via smart cards, which are secure, encrypted, password protected cards that are a portable method of accessing and transporting a youth's personal information and records. The cards are granted either to a user of the system, or the foster child directly, or in a preferred embodiment of the invention, both. Accessing the information on the cards requires a card reader, a password matching a password embedded on the card, and software capable of reading the data on the card. Such equipment is generally issued to the youth and those people most closely associated with the youth's foster life, such as foster/adoptive parents, and community partner staff members involved in their care. The system runs on a personal computer such as a desktop or laptop connected to the Internet. Once all the equipment has been issued, the card, the software, and the server (via the Internet) are synchronized and simultaneously updated at that time and thereafter.

The Applicant's system obtains its data via existing legacy databases in the state or county in which the system is implemented. For federal implementation, the Applicant's system can be adapted to federal databases. The data preferably automatically updates from existing systems where possible but in some cases (such as records existing on paper only), manual entry may be necessary. The system includes a graphical user interface that is used by a user to view and/or modify data, and access is granted through a smart card assigned to either the user or the foster youth.

The Applicant's system is an important key needed by the foster youth to maintain critical educational and medical information. Centralized data systems, such as the Statewide Automated Child Welfare Information Systems (SACWIS), exist to capture certain data reflecting services to foster youth. Applicant's system is intended to be complementary and compatible with systems such as SACWIS. Many agencies in the foster care system offer services to needy foster and emancipated youth. Linking this data will show a youth's positive progress through the system.

In summary, the Applicant's system discloses a youth centric secure portable key to the critical life data of children (individuals) and others. This Internet-based, real-time data collection system enables children (individuals) and their providers to access specific data to the individuals. Where the individuals are children moving through the foster care system, the system provides a solution to the difficult problem of tracking these children's data. An important facet of the Applicant's system is that all data is associated with the youth, and all data must be entered according to fields designed to follow the youth.

Recent upgrades to the Applicant' system have made the system vastly superior to its previous forms. Improvements include forms that automatically populate from data contained in the system, an added capability to allow the use of email forms, photo records, to generate reports directly from the system to external parties, and most importantly, to improve the compatibility of the system with existing system and databases already in place to the degree that the objects and purposes of the invention are possible.

### BRIEF DESCRIPTION OF THE DRAWINGS

FIG. 1 depicts a flowchart of the Applicant's system from a data transfer perspective and from a preferred embodiment of the invention.

FIG. 2 depicts a flowchart of the Applicant's system according from a data storage perspective and from a preferred embodiment of the invention.

FIG. 3 illustrates an example screenshot of an example graphical interface showing the “General Information” sub-sub-tab of the “Youth” sub-tab of the “Community” tab graphical interface according to an embodiment of the present invention.

FIG. 4 illustrates an example screenshot of an example graphical interface showing the “Schools” sub-tab of the “Organization” tab graphical interface according to an embodiment of the present invention.

FIG. 5 illustrates an example screenshot of an example graphical interface showing the “Immunizations” sub-tab of the “Reports” tab graphical interface according to a preferred embodiment of the present invention.

FIG. 6 illustrates an example screenshot of an example graphical interface showing the “Birth Details” sub-sub-tab of the “Personal History” sub-tab of the “Resource Lists” tab graphical interface according to a preferred embodiment of the present invention.

FIG. 7 illustrates an example screenshot of an example graphical interface showing the “Adjudicated Offense Types” sub-sub--tab of the “Judicial” sub-tab of the “Resource Lists” tab graphical interface according to a preferred embodiment of the present invention.

FIG. 8 illustrates an example screenshot of an example graphical interface showing the information about a youth's father according to an alternative embodiment of the present invention.

FIG. 9 illustrates an example screenshot of an example graphical interface showing the information about a youth's mother according to an alternative embodiment of the present invention.

FIG. 10 illustrates an example screenshot of an example graphical interface showing the information about a youth's birth history according to an alternative embodiment of the present invention.

### DETAILED DESCRIPTION OF THE INVENTION

In summary, the Applicant discloses a system comprising a secure and portable storage medium that empowers youth to maintain and utilize their personal medical and educational information, and that provides a tangible hook and key to the youth's records. The system is designed to import data from various governmental agencies' databases and other organizations in a manner in which heretofore has not been accomplished.

For purposes of this application, “youth” and “foster youth” will refer to the foster children for whose records the Applicant's system is designed to track. “User” may be defined as any user of the Applicant's system who reviews, adds, edits, deletes or otherwise manages data. In some cases, it may be that the youth whose information is being managed will be the same user who is managing that data. For purposes of data entry, the terms “edit” and “update” in regard to data entry will have the same meaning.

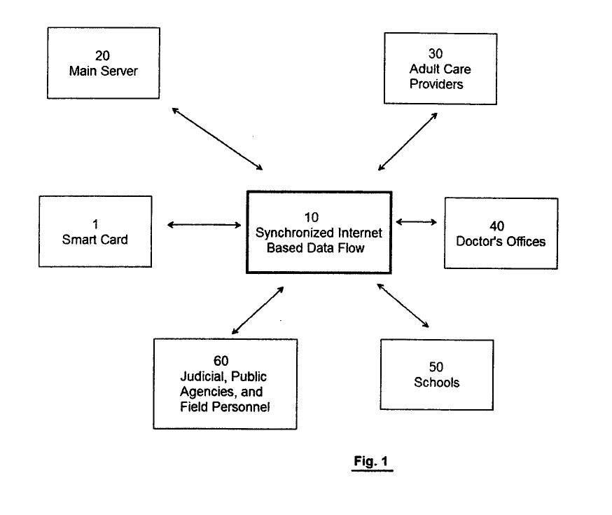

Turning now to FIG. 1, information is transferred in a preferred embodiment via a synchronized Internet based data flow 10, as shown. Information may be transferred at any time 24 hours a day, 7 days a week, and 365 days a year to a main server 20. This transfer of information may be as simple as merely sending files over the Internet, to more complex secure FTP connections, or any other means for sending data across a network that are at present well known in the art. Additionally, the server provides standard system management and disaster recovery features common in the art. Information from this server may ultimately be transferred to a client database or to the youth's smart card 1 through the synchronized Internet based data flow 10. Upon entry into a foster care system, the youth receives a smart card 1 that is to contain data comprising health and education information and that is ultimately populated by the other databases as shown in FIG. 1.

Smart card 1 is similar in size and material to a credit card, and is embedded with an encrypted computer chip that stores and transacts real-time data in a portable, secure, password-protected format. The foster child is initially assigned a card by a social worker assigned to his or her care. He or she creates a card using password and security implementation software and a smart card reader/writer. If a youth loses his or her smart card, a new card may be written for the youth and the old card is invalidated. If someone finds the card and attempts to access the information thereon, it is not possible to do so without the entry of a password matching that password on the card. After three failed attempts to enter a password for the user, a microchip on the smart card self-destructs, rendering the card useless.

The Applicant's system obtains its data from existing legacy databases in the state, county, or country in which the system is implemented. Data may come from agencies and services including but not limited to child welfare (children's services), schools, juvenile courts, medical facilities (physicians, hospitals, clinics, dentists etc.), private foster care agencies, foster parents, guardian ad-litems, probation officers, hospital contacts, school contacts, school district contacts, the youth themselves, emergency contacts, caseworkers, caseworker supervisors, caseworker section chiefs, mothers, fathers, caregivers, and siblings.

Everyone involved in the youth's care can update the youth's critical information in the same way. For example, if the youth visits the doctor and receives immunizations, the doctor's office would use the Applicant's software, update the youth's information, synchronize that to a server and return the child's smart card to him or her with the new information. The youth's school can then view the youth's records online to verify proof of immunization immediately, rather than delaying enrollment because of missing paperwork. Even if a card is misplaced or damaged, the data is encrypted and archived on the server and any official with access rights and the proper password can retrieve the information associated with that child through alternative and secure means. The purpose of the Applicant's system is to link all agencies involved in the child's care, empower foster youth and increase the chances for successful emancipation. The system has been created with a novice computer user in mind. Teachers, health care providers, social workers, care givers—all individuals involved the youth's well being can participate in contributing data.

The information entered is stored on the individual child's smart card, on the user's desktop, and on a central database located on the main server 20. The information is synchronized to ensure that the most current information is in all three locations. The information can be entered online or offline. If information is entered offline, the next time the user's computer is logged onto the Internet, the information is automatically synchronized and updated to main server 20. Each user's smart card allows the user to view information only on the child within his or her jurisdiction. An individual child's smart card will only record information for that specific child. When a smart card is inserted into the reader both the card and the computer client are updated.

Continuing with FIG. 1, adult care providers 30 transfer information to and from the system as they view and update records as needed for the youth in their care. Doctor's offices 40 may view and update medical records, schools 50 may view and update educational records, judicial, public agencies, and field personnel such as local, state and federal agencies, CWS/CMS, and Human Service Providers may view and update records and information on the youth under their supervision. Information from the adult care providers 30, doctor's offices 40, schools 50, and judicial, public agencies and field personnel 60 may update the smart card 1 through the synchronized Internet data flow 10. Because of the inherent flexibility of the Applicant's system, FIG. 1 is not intended to be all encompassing. The flexibility of the Applicant's system allows myriad data sources not shown on FIG. 1 may also be sourced to update the data connected to a foster youth.

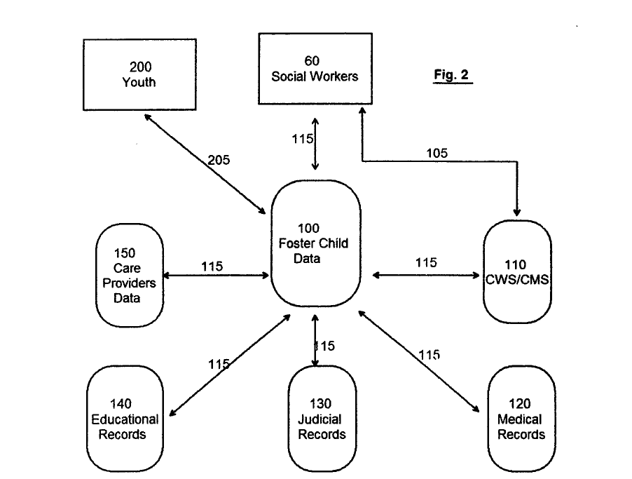

Turning now to FIG. 2, the system from FIG. 1 is shown again but from a database perspective. All foster child data 100 can be found on the main server 20 (See FIGS. 1 and 2). This foster child data 100 may be updated via controlled data transfer as shown by controlled data transfer arrows 115. The arrows are bidirectional because in some cases, transfer will be from foster child data 100 to other sources. Controlled data transfer 115 is in a preferred embodiment may be a form of synchronized Internet based data flow 10 as depicted in FIG. 1. Returning now to FIG. 2, the system is able to link to various existing and legacy systems through a data exchange server through which the controlled data transfer 115 occurs.

An example implementation of legacy and existing systems is shown in FIG. 2 where social workers 60 are shown through arrow 105 updating information into a Child Welfare Services/Case Management System (CWS/CMS) 110. From CWS/CMS, the data may be sent through the controlled data transfer 115 to the main collection site foster child data 100. By using the CWS/CMS 110 intermediate between the social workers 60 and the foster child data 100, the integrity of each database is further maintained. Additionally, the foster workers can also update the foster child data 100 directly, and vice versa. The system is also compatible and complimentary to various Statewide Automated Child Welfare Information Systems (SACWIS) already in place, and can be easily adapted to other similar systems.

Further due to the high flexibility of the system, there are cases where the foster child data 100 may be more up to date then the “source” from which the data is generally mapped. For instance, if a foster child went to the school nurse and had a medical injury evaluated, this data could at a later data be sent through arrow 105 to the child's medical records 120. Hence, through synchronization, all databases are kept up to date.

Continuing with FIG. 2, medical records 120 may also be inputted and integrated with the foster child data 100 via controlled data transfer 115. Medical records are a snapshot of the youth's emergency medical information, basic medical information, immunization record, and current medications.

Judicial records 130 may also be inputted and integrated with the foster child data 100 via controlled data transfer 115.

Educational records 140 may also be inputted and integrated with the foster child data 100 via controlled data transfer 115. The applicant's system provides for data concerning educational testing, placement and student achievement to accompany the student from school to school. There are vast amounts of data that may be tracked with the student with regard the student's education.

Care Providers Data 150 may also be inputted and integrated with the foster child data 100 via controlled data transfer 115. This data comprises both data regarding the care providers and data gathered by the care providers.

When the youth is emancipated and removed from the foster system at adulthood, the youth at that time owns and maintains the personal information from foster child data 100. This transfer of data from foster child data 100 to youth 200 is represented on FIG. 2 as arrow 205. At that time or at earlier times, the youth may also be a source data for foster child data 100. The youth may in some circumstances also receive information about his or her foster child data 100 at a time before emancipation.

As stated above, the Applicant's system obtains its data via existing legacy databases in the state, county or country in which the system is implemented. At any given moment, many of these agencies/organizations are extremely busy, have limited resources (in terms of both staff and funds) and could have adversarial relationships with one another. Thus, automation of the system is critical. While generally the data can be populated automatically from these legacy systems in order to keep the level of extra man-hours needed to a minimum, at times manual entry of data is needed. Manual entry is generally only needed when the medical and education records of question are only available in paper form, such as youth case files, school records, and old medical records). During normal automated procedures, data mapping and integration may be accomplished using conventional database software, such as SQL 2005 Enterprise and .NET from Microsoft Corp.

One goal of the system is to limit the amount of duplicated data entry while keeping data current secure and accessible to the child and service providers. The process begins with a System Administrator setting appropriate access rights for the various agency participants. Next the system begins data collection with an initial data transfer of foster care data from the legacy systems. The information is imported into the system. Then as youth enter, move, and receive services throughout the system data is collected at the point of service, such as a medical provider entering medical treatment.

The smart card system allows data to travel with the foster care children as the children move through the foster care system and allows the continuous updating of the appropriate database that serves these children. This smart card enables the children and their providers (who are oftentimes “users”) to have access to this requisite data as the children move through the foster care system. The foster care youth's details are stored in a database that is easily accessible and shared between stakeholders—individuals, state, county and local social service agencies, care providers, medical providers, and educational institutions—using the proprietary technology and the Internet. In the event of a lost card, natural disaster, or electronic malfunction, the individual's data is backed up and available from the central server to authorized users.

Because a large amount of personal data is stored in the system and is designed to be accessible to various users, user rights are an important component of the applicant's invention. User rights may be assigned either by editable field or by user. That is, certain fields can be set up so to only allow viewing, editing, deleting etc. by certain users. For example, medical providers are allowed full access to medical information while a school provider may only see medical provider data and immunization data, but not medical diagnosis or medical treatment data.

The user rights level assigned to a group of users will determine the information accessible to those users. The agency's or organization's system administrator sets user rights. Users are assigned access rights so they are able to access information on an as-needed basis. For example, a county children's services case worker will only be able to see or access information on foster youth on his or her individual case load. Within the individual foster youth screens, this case worker will only have access to information that he or she is entitled to see as designated by federal, state and local laws, regulations, and rules. The access rights assigned to each user protect the confidentiality of the foster youths' information.

User groups in a preferred embodiment of the invention comprise caregivers/foster parents, children services county staff, judicial system, medical provider, private foster care provider, school/education, and the youths themselves. Certain users can have blanket rights assigned to them, such as view only. The user rights may also be controlled through assignment of various user “levels” to each user. In a preferred embodiment of the invention, the user levels are defined below.

User Level 1 in an embodiment of the invention allows a user to view, add, update and delete all data elements. Due to the power granted to level 1 users, in a preferred embodiment only system administrators are level 1 users.

User level 2 in an embodiment of the invention allows a user to view, add and update all data elements.

User level 3 in an embodiment of the invention allows a user to view and update all data elements.

User level 4 in an embodiment of the invention allows a user to view all data elements only.

In addition to the above generic user levels of access, various class specific levels have been designed, examples of which are given below:

Foster Parent Level 4 allows viewing but with exceptions. Here, the foster parents view does not allow view access (or any other access for that matter) to data regarding the father, mother, and sibling information.

Medical Level 2 allows data viewing, adding, and updating but with exceptions. Medical providers can add and update immunizations, medical providers, mental health, mental health prescription, medical diagnosis, medical treatment, surgery, and hospitalization. Medical providers can view general information, placement, caseworker, and private FC. Medical providers can view school information and selected information on education information, such as grade, grade school year, special education, 504 accommodation plan, IEP, and disabilities.

School level 2 allows data viewing, adding, and updating again with exceptions. Here, school personnel can add and update school information, education information, and proficiency scores. They can only view general information, placement, caseworker, private foster care, immunizations and selected information regarding the youth's medical provider, such as medical provider name, medical provider phone number and email address, specialty type, and physician name. On the medical history screen, school personnel can view screening tests, treatments, infectious diseases, illicit drug exposure, med diagnoses, vital signs and growth, surgeries, and hospitalizations (but nothing related to mental health). School personnel cannot view probation/delinquency, court information, father information, sibling information, mother information, mother medical history, and childbirth history.

Judicial level 2 allows data viewing, adding, and updating again with exceptions. Judicial level 2 users can view general information, placement, caseworker, private foster care data, immunizations, medical provider, medical history, school information, education information, and proficiency scores. Judicial level 2 can add and update probation/delinquency, court information, father information, sibling information, mother information, mother medical history, and childbirth information.

Table 1 below shows sample levels associated with different classes of user. For each class, a checkbox shows whether that class may view, add, update and or delete records. A further definition of the rights associated with the class of users appears under the definitions portion.

TABLE 1

| Type | Level | Categories within Group | View | Add | Update | Delete | Definitions |
|---|---|---|---|---|---|---|---|
| Caregiver/Foster | Level 3 | Foster Parents | x | | x | | View and update all data elements |
| Parent | | | | | | | except father, mother and sibling |
| | | | | | | | information and mother name on |
| | | | | | | | childbirth history screen. |
| | Level 4 | Foster Parents | x | | | | View all data elements except father, |
| | | | | | | | mother and sibling information and |
| | | | | | | | mother name on childbirth history |
| | | | | | | | screen. |
| Children Services | Level 1 | Group (System) | x | x | x | x | View, Add, Update and Delete all data |
| County Staff | | Administrator | | | | | elements |
| | Level 2 | Caseworkers - FC, | x | x | x | | View, Add and Update all data elements |
| | | Adoption, Intake, Ongoing, | | | | | |
| | | 241-Kids, Out-of-Home | | | | | |
| | | Care, IL, UM, | | | | | |
| | | Supervisors - FC, | x | x | x | | View, Add and Update all data elements |
| | | Adoption, Intake, Ongoing, | | | | | |
| | | 241-Kids, Out-of-Home | | | | | |
| | | Care, IL, UM, | | | | | |
| | | Administrative | x | x | x | | View, Add and Update all data elements |
| | | Case Aids | x | x | x | | View, Add and Update all data elements |
| | | Clerical - Intake, Ongoing, | x | x | x | | View, Add and Update all data elements |
| | | Children Services/Court | | | | | |
| | | Info Specialist | | | | | |
| | | Trainers | x | x | x | | View, Add and Update all data elements |
| | Level 3 | Adoption clerical | x | x | | | View and Update all data elements |
| | Level 4 | SAR/Family Team | x | | | | View all data elements |
| | | Foster/Adoption Recruiters - | x | | | | View all data elements |
| | | Sup., Case Workers | | | | | |
| | | Administration - Director, | x | | | | View all data elements |
| | | Asst. Director, Executive | | | | | |
| | | Asst, Consumer Complaint | | | | | |
| | | Officer | | | | | |
| | | Administrative Assistant | x | | | | View all data elements |
| | | Data Analysis - Adm, | x | | | | View all data elements |
| | | Program Manager, | | | | | |
| | | Program Evaluator, | | | | | |
| | | Business Analyst | | | | | |
| | | IT staff/Help Desks | x | | | | View all data elements |
| | | Quality Assurance | x | | | | View all data elements |
| | | Choices - Adm, Adm Asst, | x | | | | View all data elements |
| | | Case Worker | | | | | |
| | | Section Chief/Manager | x | | | | View all data elements |
| | | Clerical - Foster Care | x | | | | View all data elements |
| | | Foster Care/Adoption | x | | | | View all data elements |
| | | Home Study Assessors - | | | | | |
| | | Supervisors/Caseworkers | | | | | |
| Judicial System | Level 1 | Group (System) | x | x | x | x | View, Add, Update all data elements |
| | | Administrator | | | | | |
| | | Administration | x | x | x | | View, Add and Update all data elements |
| | Level 2 | Administrative Assistant | x | x | x | | View, Add and Update all data elements |
| | | Clerical | x | x | x | | View, Add and Update all data elements |
| | | Judge | x | x | x | | View, Add and Update all data elements |
| | | Magistrate | x | x | x | | View, Add and Update all data elements |
| | | Probation Officers | x | x | x | | View, Add and Update all data elements |
| | | Probation Supervisor | x | x | x | | View, Add and Update all data elements |
| | Level 4 | Information Technology | x | | | | View all data elements |
| Medical Provider | Level 1 | Group (System) | x | x | x | x | View, Add, Update all data elements |
| | | Administrator | | | | | |
| | Level 2 | Administration | x | x | x | | View, Add and Update all data elements |
| | | Clerical/Registration Staff | x | x | x | | View, Add and Update all data elements |
| | | Physicians | x | x | x | | View, Add and Update all data elements |
| | | Juvenile Court Medical | x | x | x | | View, Add and Update all data elements |
| | | Service Provider | | | | | |
| | | Nurses | x | x | x | | View, Add and Update all data elements |
| | Level 4 | Information Technology | x | | | | View all data elements |
| Private Provider | Level 1 | Group (System) | x | x | x | x | View, Add, Update all data elements |
| | | Administrator | | | | | |
| | Level 2 | Administration | x | x | x | | View, Add and Update all data elements |
| | | Case Worker | x | x | x | | View, Add and Update all data elements |
| | | Clerical | x | x | x | | View, Add and Update all data elements |
| | | Supervisor | x | x | x | | View, Add and Update all data elements |
| | | Therapists/Mental Health | x | x | x | | View, Add and Update all data elements |
| | | Workers | | | | | |
| | Level 4 | Administration | x | | | | View all data elements |
| | | IT staff/Help Desks | x | | | | View all data elements |
| School/Education | Level 1 | Group (System) | x | x | x | x | View, Add, Update and Delete all data |
| | | Administrator | | | | | elements |
| | Level 2 | Administration | x | x | x | | View, Add and Update all data elements |
| | | Nurses | x | x | x | | View, Add and Update all data elements |
| | | Principals | x | x | x | | View, Add and Update all data elements |
| | | Clerical Staff | x | x | x | | View, Add and Update all data elements |
| | | Teachers | x | x | x | | View, Add and Update all data elements |
| | | Truancy Officers | x | x | x | | View, Add and Update all data elements |
| | Level 4 | Information Technology | x | x | x | | View, Add and Update all data elements |
| | | Administration | x | | | | View all data elements |

Additionally, various types of reports can be generated from the data stored at foster child data 100. Again, for security purposes, the various reports that may be generated are each accessible only to designated users. For instance, a caseload report is only available to a caseworker, a caseworker supervisor, a data analysis group, and a section chief. Table 2, below, details example reports and classes of users who may view them.

TABLE 2

| Type of Report | Classes of Users who may Access Report |
|---|---|
| Caseload Report | Caseworker, Supervisor, Data Analysis Group, and Section Chief |
| Child Annual Physicals | Care Provider, Medical Provider, Caseworker, Supervisor, Data Analysis |
| Due Report | Group, and Section Chief |
| Child Education Report | School, Care Provider, Caseworker, Supervisor, Section Chief, Data |
| | Analysis Group, Court Contact, and Probation Officer |
| Child Proficiency Score | School, Care Provider, Caseworker, Supervisor, Section Chief, Data |
| Report | Analysis Group, Court Contact, and Probation Officer |
| Hospitalization Report | Medical Provider, Care Provider, Caseworker, Supervisor, Data Analysis |
| | Group, and Section Chief |
| Immunization Report | Medical Provider, Care Provider, School, Caseworker, Supervisor, Data |
| | Analysis Group, and Section Chief |
| Medical Provider Report | Medical Provider, Care Provider, School, Caseworker, Supervisor, Data |
| | Analysis Group, and Section Chief |
| Medical Summary Report | Medical Provider, Care Provider, School, Caseworker, Supervisor, Data |
| | Analysis Group and Section Chief |
| Placement Report | Care Provider, Medical Provider, Care Provider, School, Caseworker, |
| | Supervisor, Section Chief, Data Analysis Group, Court Contact, and |
| | Probation Officer |
| Private Foster Care | Private Care Provider, Private Care Supervisor, Caseworker, Supervisor, |
| Provider Caseload Report | Data Analysis Group, and Section Chief |
| School Placement Report | School, Care Provider, Caseworker, Supervisor, Section Chief, Data |
| | Analysis Group, Court Contact, and Probation Officer |

As stated previously, each smart card is encrypted and the data thereon cannot be viewed without the appropriate user rights. Various levels of access are granted to users of the system wherein the higher the level of access granted, the more details regarding the status of youth and data regarding events surrounding the youth may be viewed and/or modified. The smart card reader has a complementary security system that works with the smart card according to conventional smart card security means. As stated above, after three failed attempts to enter a password for the user, a microchip on the smart card self-destructs, rendering the card useless.

Critical software patches are tested internally and then deployed over the Internet to update the Applicant's hardware and software. Should any additional security measures be needed, this is a fast and efficient means of implementing them. Each maintenance item (software or hardware) is tested in a separate environment before it is deployed in a production environment. Software upgrades or enhancements that add or improve features to the system are typically performed every quarter.

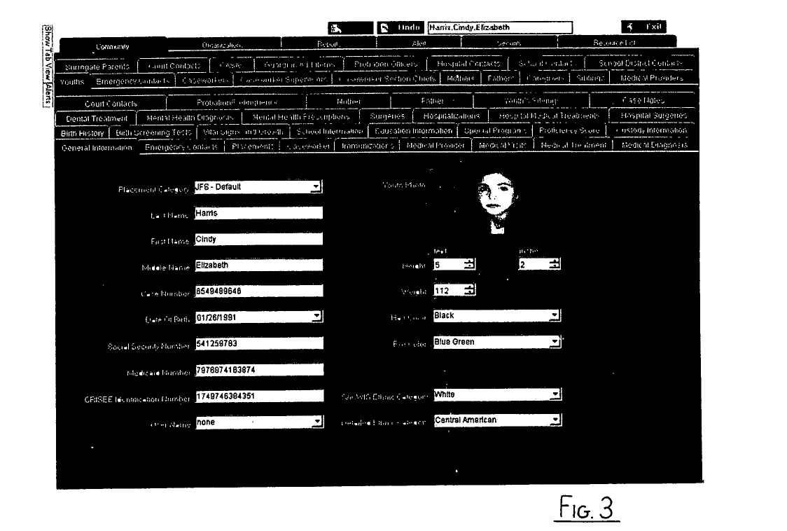

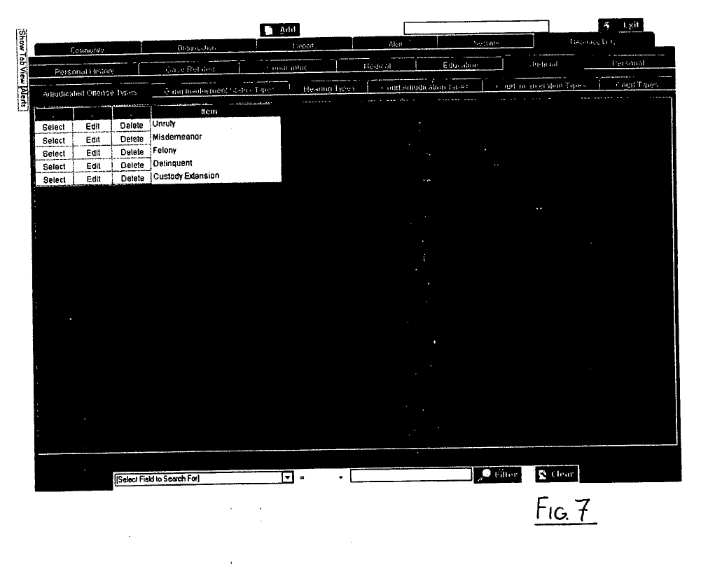

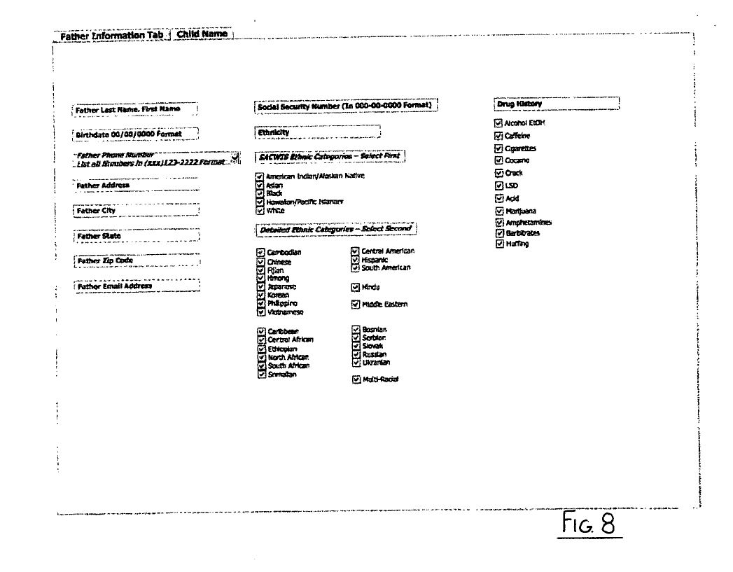

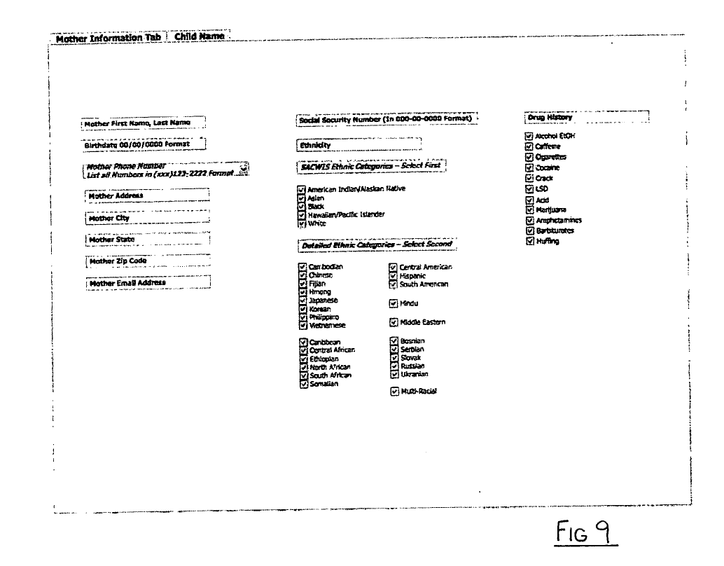

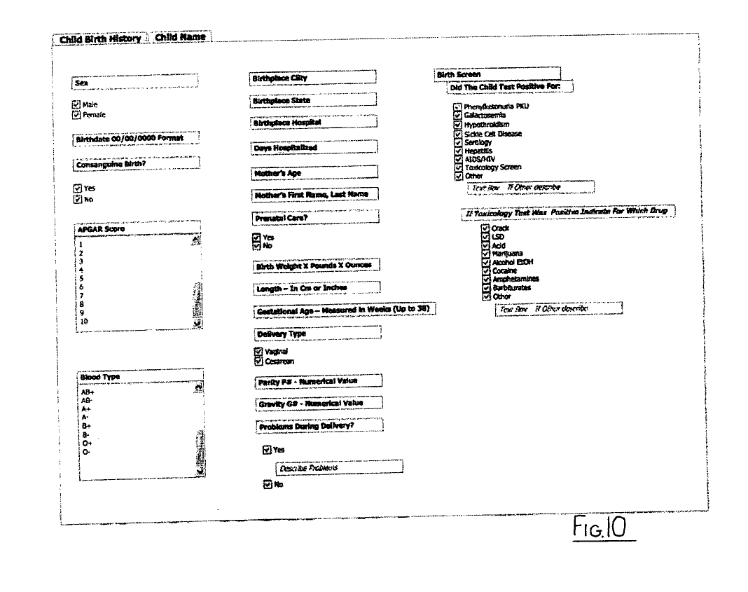

FIGS. 3-10 show various examples a graphical user interface according to an embodiment of the present invention. FIGS. 3-7 show examples according to a preferred embodiment of the invention and FIGS. 8-10 show examples according to an alternative embodiment of the invention. In either case, the graphical user interface is designed to allow a user to easily edit various fields, and may further be designed for use in exclusively pointer-based computer system or for those where the only input is through a keyboard. Various editable objects may be highlighted and are preferably designed by editing handles provided at designated positioned relative to said editable objects. The editing steps are preferably repeated until the user is satisfied with the visual depiction of the data shown, at which time the data may be saved.

As shown in FIGS. 3-7, the graphical interface is designed to resemble a notebook complete with specific tabs. Users can “flip” through the tabs viewing all the tabs or only those that need viewing or updating. Tabs that a user does not have user rights to view are not visible to the user. Navigation through the tabs is accomplished in two ways. The main window of the application contains a group of folders that contain all of the data entry screens and reports available to the particular user based on that user's user rights. A taskbar is located at the top of each report tab that allows for common Windows-based actions. Although a tab view is shown in FIGS. 3-7, in an alternative embodiment of the invention a hierarchical view of all data may be displayed.

Each user has the ability to view, update, add or delete information on the tabs. User rights are assigned based on the requirements of that specific user. On each of the screens information may be inputted.

In a preferred embodiment of the invention, several top-level tabs will each contain sub-tabs, and then sub-sub-tabs within said sub-tabs. A typical community tab screen screenshot from the Applicant's system is shown as FIG. 3. The community section contains information specific to each child. A community member in this sense is an individual who is involved in the life of the foster youth. The tab shown in FIG. 3 has open a sub-tab called youth and within that a sub-sub-tab called “general information” is open. The community tab comprises the following sub-tabs: youths, emergency contacts, caregivers, caseworkers, caseworker supervisors, caseworkers section chiefs, fathers, mothers, siblings, probation officers, hospital contacts, court contacts, school contacts, school district contacts, surrogate parents, CASAS, GALs, and medical providers. The youths sub-tab comprises the following sub-sub-tabs: General Information (open on FIG. 3), emergency contacts, placements, caseworker, immunizations, medical provider, medical diagnosis, medical treatment, dental treatment, mental health diagnosis, mental health prescriptions, surgeries, hospitalizations, hospital medical treatments, hospital surgeries, birth history, birth screening tests, vital signs and growth, school information, education information, special programs, proficiency scores, court information, court contacts, probation/delinquency, mother, father, youth's siblings, and notes.

Each sub-tab and sub-sub-tab contains more fields that may be auto-populated or entered manually by a user.

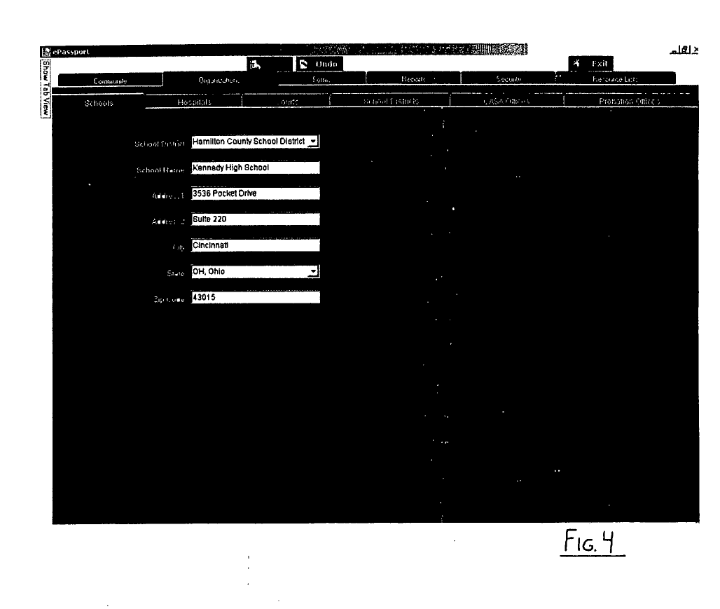

A typical organizations tab is shown in FIG. 4, wherein a “schools” sub-tab is open. A typical organizations tab comprises sub-tabs for schools, school districts, hospitals, courts, CASA offices and probation offices.

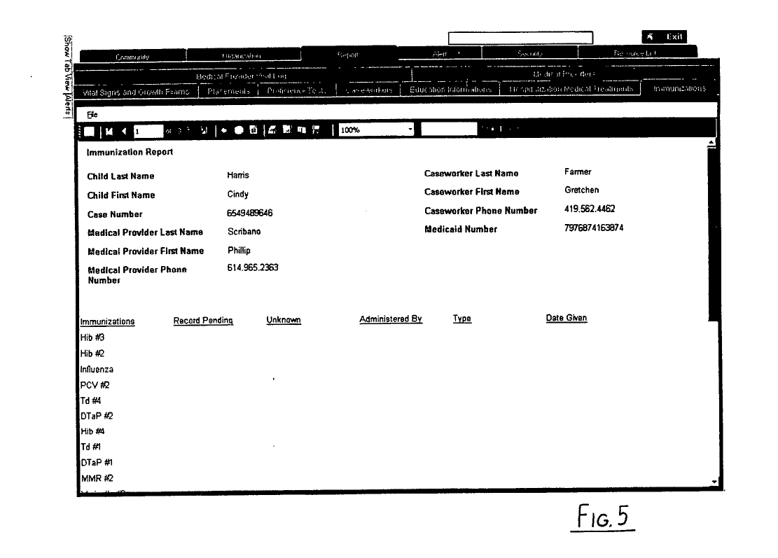

Referring now to FIG. 5, the reports tab allows reports to be printed that contain information about the youth. The report open in FIG. 5 is in regard to immunizations the youth has had. The Immunizations tab provides the ability to capture and track the immunizations of any child whose record is contained in the Applicant's system. Incorporated into this tab is a tickler system to alert Medical Providers and Case Workers of any missing immunizations. Generally for outputting reports particular criteria are selected and the associated, previously entered data elements are presented in formatted print page format. Reporting allows users to view information entered into many different screens/tabs in a meaningful business format. Reports are filtered based on access level permissions predefined for the group to which the logged user belongs.

The forms tab (visible on FIGS. 3-7, but not opened) allows the user to add additional information to print common forms and export documents.

The alerts tab (visible on FIGS. 3-7, but not opened) allows the user to see special notices about the youth. The system administrator can also send alerts to users regarding system issues.

The security tab (visible on FIGS. 3-7, but not opened) allows the system administrator to set access levels and rights for users. This section is restricted to the system administrator and on a limited basis to Program Supervisors. The security tab includes three main areas: user tab, user access tab, and smart cards tab. This is the section where the various users involved in the system are assigned access rights. Users are assigned access rights so they are able to access information on an as-needed basis. The user tab section is the section to create user names and passwords to log into the application.

Within the user access tab there are five sub-tabs to set specific user rights. An “Access level Types” tab is where the levels for each main user group type (such as Medical Provider, Private provider, and Judicial, etc) are set. An “access levels” tab allows the assignment of a subgroup such as caregiver level 1, 2 or 3 to a larger group such as caregiver/foster parent. This tab also allows the creation of subgroups to further define access rights for each individual user level (level 1, 2, 3 etc.) on a very flexible and custom level. An “access level per screen” tab is where rights may be set to a user to add, delete, transfer, edit, and view each entity contained in the system. These rights are set at the entity level only. Further rights can be defined on an “access per field” tab described below. The “access per field” tab allows further definition of rights to the field level. Entities contain several different fields and this tab allows the restriction of any of those fields as chosen by the system administrator.

The security tab is also the tab used to create new smart cards. When making new records for a child, advisor, or care provider, a smart card can be written. Cards for children contain all information on that individual child. Cards written for advisors or care providers (collectively: users) are operator cards that allow access to the system and the appropriate records. To write a card the user information must be set up first. Under the security tab, a new user or foster youth may be entered into the system. After adding the individual and setting the user's rights, a sub-tab for writing cards may be opened. During this process, the program prompts the user or system administrator to insert a smart card to the card reader/writer so that the card may be initialized.

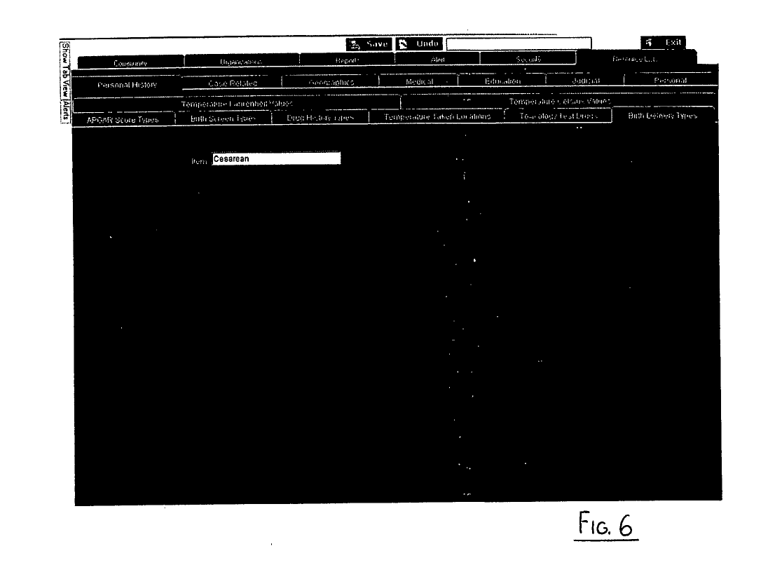

The resource lists tab is shown opened on FIG. 6. Specifically, FIG. 6 shows a sub-tab “Personal History” that has been opened and a sub-sub-tab “Birth Delivery Type” that has been opened. Resource lists allow the system administrator to input information tags related to various program elements. The lists here are supplemental information (information tags) that are utilized by the program to populate various fields in various screens. The resource lists include: case related, miscellaneous, personal (medical) history, geographies, medical, education, judicial, and personal. These information tags in the various resource lists tabs are added, edited, and deleted by the system administrator.

The case related tab within the resource lists tab comprises the following sub-tabs: placement types, placement categories, placement status types, and case note types. In the placement types sub-tab under the case related tab, there is one column entitled item. The column can be edited to indicate the placement types that are used for a particular entity. For example, item lists may include: guardian, foster home (county), out of county, group home, independent living, protective custody, interstate, emergency shelter, purchases care facility, hospital, detention, residential facility, AWOL, treatment foster home (network), and kinship. In the placement categories sub-tab the column can again be edited to include labels such as CPS-homeless, jobs and family services, juvenile court and TFC-out of county. In the placement status types sub-tab the column can be edited here to indicate the placement status types that are used for a particular entity. Item lists in a preferred embodiment may include temporary custody, PPLA, adoption pending, protective custody, emergency custody/exparte' detention, and custody. In the “case notes” sub-tab under the case related tab, there is one column entitled item. The column can be edited to indicate the case note types that are used by a particular entity. In one example of the invention, the items list includes: children's service county staff, judicial system, medical provider, caregiver/foster parent, private provider, and education. In these and all other tabs, the choices may be individually tailored to fit the particular implementation of the program. For instance, one state may have a jobs and family services agency while another will have a similar agency that has a different name. In this case, the applicant's system would be customized before implementation.

The personal (medical) history tab within the resource lists tab comprises the following sub-tabs: APGAR score types, birth screen types, drug history types, immunization types, temperature taken locations, and toxicology test drugs. Birth screen types may include AIDS/HIV, toxicology screen, hepatitis, hypothyroidism, serology, PKU, sickle cell disease, other, and galactosemia. Drug history types may include methamphetamines, alcohol EtOH, cigarettes, caffeine, huffing, amphetamines, PCP, acid/LSD, barbiturates, marijuana, crack, and cocaine. Temperature taken locations can include oral, forehead, finger, rectal, and ear. Toxicology test drugs can include drugs similar to the drugs listed under drug history types above.

The geographies tab within the resource lists tab is where the location of the youth may be entered. Generally it is entered as a state.

The medical tab within the resource lists tab comprises the following sub-tabs: dental treatment types (such as bleaching teeth or wisdom teeth removal), medical service types (such as check up, vision assessment, and developmental assessment), medical specialty types (such as pulmonary, psychiatry, OB-GYN etc.), medical treatment types (such as allergy testing, antibiotic therapy, cast and chemotherapy), mental health diagnosis types (such as acute stress disorder, anorexia nervosa, bulimia nervosa, disruptive behavior disorder etc), mental health prescription types (such as lorazepam, trazodone, and venlafaxine), mental health treatment types (such as family, group, or individual), surgery types (such as appendectomy, laceration repair, or tooth extraction), and immunization types (such as MMR#1, MMR#2, and influenza).

The education tab within the resource lists tab comprises the following sub-tabs: GPAs, school grades, school years, special programs, and IEP disability types.

The judicial tab within the resource lists tab comprises the following sub-tabs: adjudicated offense types, gang involvement status types, hearing types, court adjudication types, and court incarceration types. Adjudicated offense types can be edited to list the type of offense the foster youth has been involved in, such as custody extension, felony, unruly, delinquent, and misdemeanor. Gang involvement status type can be edited to indicate whether the foster youth has been involved in gang activity. Hearing types can be edited to indicate the type of hearing the foster youth has been involved in or has coming up. Example hearings include PPLA (planned permanent living arrangement), permanent custody, emergency custody, temporary custody, court ordered protective custody, and dependency. Court adjudication types can be edited to indicate the type of adjudication the foster youth has been designated. Examples include unruly neglect, custody change, abuse, custody extension, and delinquent. Court incarceration types can be edited to indicate the incarceration type the foster child was in. Examples may include detention, house arrest, and protective custody.

The personal tab within the resource lists tab comprises the following sub-tabs: hair color, eye color, SACWIS ethnic categories, detailed ethnic categories, blood types, phone types, and gender types.

The Figures selected by the Applicant for this application were selected to illustrate the type of information that can be collected by the Applicant's systems. The screen shots included with this patent application are just a few of the screens available in the system. One novel aspect of the system is that it is designed to be implemented in a variety of situations, in a variety of states, districts, or areas, each with their own data fields and databases. For instance, one county may track only the middle initial of a child while another may track the entire middle name. The fields of data may be updated specifically for each county. The latest version of the system affords great flexibility and is built upon modules that can be easily created or modified to meet current or future business requirements. This “module” concept allows the rapid development of the application and greatly diminishes the time spent to develop a large-scale system.

Throughout the Applicant's software a search function for each screen allows the user to search for a particular record on each individual youth, or through all records the user has access to. Typical search criteria such as equals (=) for exact matches and less than (<) for matching data that is less than a given numeric value may be used.

To implement the Applicant's system of managing foster youth data, the process begins with a System Administrator setting appropriate access rights for various agency departments and individuals who may act as users in the system. In addition to providing security, this will also limit the amount of duplicated data entry efforts while at the same time keeping the data current, secure, and accessible to the child and service providers.

Next the system begins data collection with an initial data transfer of foster care data from the legacy systems. The information is imported into the system using conventional data mapping and integration processes. Then as youth enter, move, and receive services throughout the system data is collected at the point of service, such as a medical provider entering medical treatment.

Using the graphical interface, the various users edit the objects by highlighting and editing handles near the editable objects. The editing steps are preferably repeated until the user is satisfied with the visual depiction of the data shown, at which time the data may be saved.

Turning now to the specific order of events that occur when a youth enters foster care for the first time, the following steps are performed.

As a preliminary step, a caseworker begins by opening the software and reviewing a prompt for the operator to insert a smart card. As each card has the user's password and username encrypted on it, the card is positioned with the microchip on it facing up and in toward the card reader, and is inserted into the card reader. The user is then prompted to enter the login and password information, which must match the information on the smart card in order for the user to continue. Once past the initial login steps, the foster youth's smart card is then inserted. A child's record cannot be accessed without the appropriate user card being inserted first. Now that the user is logged in and the child's card has been loaded, the following steps typically occur for a new youth entering foster care for the first time.

First, a caseworker adds the new youth to the system by clicking an add button at the top of the screen. Next, demographic detail is entered in the general information tab. Information concerning the youth's placement category, full name, case number, date of birth, social security number, Medicaid number, CRISEE identification number, height, weight, eye and hair color, SACWIS ethnicity, and detailed ethnicity may be entered. Other demographic information may be entered as well. Once all changes to this or any other tab are made, the user should click a SAVE button at the top of the screen. If the user proceeds to a new tab without first saving the edits, a message box appears with “Save Form Change First” and an Okay button. Once the Okay button is clicked the user is sent back to the screen they previously edited and should now click the SAVE button at the top of the screen. At any time if the user decides not to keep the changes that the user made to a screen or to undo a newly made record, an UNDO button at the top of the screen may be clicked.

As a second step, after the youth has been placed, the caseworker enters the placement information. Information concerning the caregiver name, placement type, placement date, placement status, and placement change reason may be entered. This data is related to where and with whom the foster youth is placed.

Third, the caseworker enters the youth's medical provider information. In a preferred embodiment this is simply found in a drop down choice box on the graphic user interface that displays a list of providers. A separate box may be checked if this provider is also the primary care provider. Fourth, a caseworker enters the youth's medical information, such as immunizations, medical diagnoses, medical treatments, mental health diagnosis, mental health treatment, mental health prescriptions, dental treatment, surgeries, hospitalizations, child birth history, vital signs and growth information.

Fifth, the caseworker enters the child's educations information. This information may include school information, educations information, proficiency scores, and special programs in which the youth is enrolled.

Sixth, the caseworker enters the youth's judicial information, such as custody information, probation and delinquency information, and court contacts.

Seventh, the caseworker enters the child's biological family information, such as information regarding the mother, father, and siblings. See FIGS. 8-10 for these screens according to an alternative embodiment of the invention.

Eighth, the caseworker enters any other notes regarding the youth, such as notes concerning allergies, childhood illnesses etc. The date at which each note is written is also entered.

Ninth, the caseworker enters the youth's emergency contact information. Preferably, the contact's full name, phone type and phone number are entered, but other information may be entered as well. The emergency contact is generally the person designated to be contacted first in case of an emergency experienced by the youth.

Tenth, the caseworker enters the youth's caregiver information. This generally includes the caregiver's full name, phone type and phone number, as well as email address. The caregivers are generally the foster parents of the youth.

Eleventh, the caseworker enters the youth's community contact information. This can include information concerning the youth's surrogate parents, CASAs (court appointed special advocates), GALs (guardian ad litems), probation officers, court contacts, hospital contacts, school contacts, school district contacts, medical providers, caseworkers, caseworker supervisors, caseworker section chiefs/directors, mothers, fathers, and siblings.

Twelfth, the caseworker enters organization information, such as information about the youth's school including school district, school name, and school address. Thirteenth, the caseworker enters school district information, which generally includes the school district name, number, and address.

Fourteenth, the caseworker enters organization information concerning the hospitals the youth has visited. For each, the hospital name and address is entered.

Fifteenth, the caseworker enters organization information concerning CASAs, such as the CASA Office name and address. This information is entered for each CASA office associated with the youth.

Sixteenth, the caseworker enters organization information concerning the youth's probation officer. Information concerning the probation officer's address and name is entered. This information is entered for each Probation Office associated with the youth.

Seventeenth, organization information concerning the courts associated with the youth is entered by the caseworker. For each court associated with the youth, information concerning the court type, the court name, and the court address is entered.

At this point the case worker has entered a great deal of information and from here the data set associated with the youth will grow as it is updated by the medical provider, the school, the foster parents etc. Another example is provided below wherein information is transmitted through the applicant's system from the foster child data 100 to a medical provider.

Here, the first step is for the caseworker to enter the youth's information into the system. This step essentially comprises the first seventeen steps outlined above. Second, the foster parent and youth utilize the smart card to provide the information to medical providers. Third, the medical provider accesses the information from the medical provider's own smart card for the youth. Fourth, the medical provider selects the youth general demographics information so it may be viewed. This information was originally entered by the caseworker.

Next, the medical provider may view the youth's placement information (such as caregiver name, placement type, placement date, placement status, placement change reason), the youth's caseworker information, the youth's medical information (such as medical provider immunizations, medical visits, medical diagnoses, medical treatment, mental health diagnosis, mental health treatment, mental health prescriptions, dental treatments, surgeries, hospitalizations, child birth history, vital signs and growth), the youth's educational information (such as school information, education information, proficiency scores, and special programs), the youth's judicial information (custody information, court contact information, probation and delinquency information), the youth's biological family information, any notes regarding the youth, emergency contact information, caregiver information, the youth's community contact information (such as surrogate parents, CASAs, GALs, probation officers, court contacts, hospital contacts, school contacts, school district contacts, medical providers, caseworkers, caseworker supervisors, caseworker section chiefs/directors, mothers, fathers, and siblings), and finally any reports.

This information may be useful in the diagnosis and treatment of the youth. Updates to this information may be entered by the medical provider to the extent the rights to do are granted as detailed in the user rights section of this application.

The results of implementing the Applicant's system are vast improvements in efficiency of data monitoring. In one implementation over 50 distinct business processes were incorporated into the system. These processes were laden with manual record retrievals, multiple units or divisions conducting the same task, dependency on hard copy records versus electronic, delays in information being updated, some units not having any information, etc. In this installation, the Applicant's found the system was able accomplish all of the 50 previous processes using only 15 concise processes that in effect were a condensed version of all the data previously managed.

This resulted in a time saving of over 150% for each unit that used the system. To continue the analysis of the time savings brought about by implementation of the Applicant's system, the Applicant established metrics for the time it takes a caseworker to collect the required information for a foster youth. Before the Applicant's system was deployed, it took a caseworker 4-6 hours to collect and log placement information for a youth going into custody. When a caseworker uses the Applicant's system it takes 1.5 to 2 hours. Many more metrics have been established such as accuracy of data, ease of retrieval, overall improvement in care for youth in custody, improvement of youth's education, etc.

Various groups benefit in various ways through implementation of the Applicant's system. The foster youth themselves benefit from reduced delays in school enrollment, complete and accessible documentation to enroll in school or apply for work, improvements in medical care through better informed care providers, reduced or eliminated duplicate immunizations, and the facilitation of a smooth transition to emancipation. To the government and organizations working with foster youth, costs are reduced and time is saved due to improved outcome tracking and measurement, better accessibility to records for appropriate entities, reductions in duplicated efforts, and increases in consistency of information across organizational boundaries. To the medical community, summarized medical records are provided, and to the educational system an immediate, accurate educational placement and review is possible.

Benefits to foster agencies and social workers include providing multiple agencies with accurate information on eligibility and services provided, increasing the sharing of appropriate information between agencies, reducing the chance of lost documents, and facilitating the coordination of efforts from all parties involved in providing services to foster children. Since the majority of service providers are not connected with state and/or county information systems such as SACWIS, the Applicant's system provides this connection. Finally, the Applicant's system reduces duplicating of services, reduces missed opportunities, reduces the chance for human error, and improves consistency among agencies and departments.

With respect to the above description, it is to be realized that the disclosed screenshots and modules may be modified in certain ways while still producing the same result claimed by the Applicant. Such variations are deemed readily apparent and obvious to one skilled in the art, and all equivalent relationships to those illustrated in the drawings and examples and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A means for collecting, storing, displaying and updating foster youth data over the Internet, said means comprising:
a. transmitting a user request from at least one user station;
b. retrieving external data sources in a plurality of different data formats and further comprising foster youth data from at least one server connected to said at least one user station;
c. providing a database for storing said foster youth data;
d. parsing selected data elements in said foster youth data into a list of individual foster child data elements; and
e. providing a graphical user interface display in accordance with said user request.

2. The means for collecting, storing, displaying, and updating foster youth data over the Internet according to claim 1, wherein said youth data is stored in a tangible portable and secure format.

3. The means for collecting storing, displaying, and updating foster youth data over the Internet according to claim 2 wherein said tangible portable and secure format comprises a first smart card.

4. The means for collecting storing, displaying, and updating foster youth data over the Internet according to claim 3 wherein said transmitting step is authorized by data contained on a second smart card.

5. The means for collecting storing, displaying, and updating foster youth data over the Internet according to claim 4 further comprising the step of assigning to a level of access to a plurality of users.

6. The means for collecting storing, displaying, and updating foster youth data over the Internet according to claim 1 further comprising the step of assigning to a level of access to a plurality of users.

7. The means for collecting storing, displaying, and updating foster youth data over the Internet according to claim 1 wherein said external data sources comprise a plurality of governmental entity databases.

8. The means for collecting storing, displaying, and updating foster youth data over the Internet according to claim 7 wherein said plurality of governmental entity databases includes at least one of a children's services database, an education database, or a hospital database.

9. The means for collecting, storing, displaying, and updating foster youth data over the Internet according to claim 8, wherein said youth data is stored in a tangible portable and secure format.

10. The means for collecting storing, displaying, and updating foster youth data over the Internet according to claim 9 wherein said tangible portable and secure format comprises a first smart card.

11. The means for collecting storing, displaying, and updating foster youth data over the Internet according to claim 10 wherein said transmitting step is authorized by data contained on a second smart card.

12. A method of collecting, storing, displaying, and updating foster youth data though a foster youth data tracking system comprising:
a. retrieving foster youth data from a plurality of external data sources in a plurality of different data formats, wherein said foster youth data corresponds to a plurality of individual youths;
b. parsing selected data elements in said foster youth data into a list comprising a plurality of individual foster child data sets stored in at least one database;
c. utilizing said at least one database via a first smart card;
d. utilizing said plurality of individual foster child data sets through a second smart card, wherein said second smart card is assigned to one of plurality of individual foster child data sets.

13. The method of collecting, storing, displaying, and updating foster youth data through a foster youth data tracking system according to claim 12 further comprising:
a. a means for organizing said list into a plurality of flexible modules.

14. The method of collecting, storing, displaying, and updating foster youth data through a foster youth tracking system according to claim 13 wherein said plurality of flexible modules includes at least one of a community module, an organization module, or a security modules.

15. The method of collecting, storing, displaying, and updating foster youth data through a foster youth tracking system according to claim 14 wherein said community module comprises at least one of an emergency contact module, a hospital contact module, or a probation officer module.

16. The method of collecting, storing, displaying, and updating foster youth data through a foster youth tracking system according to claim 12 further comprising assigning to users of said tracking system a user access level.

17. The method of collecting, storing, displaying, and updating foster youth data through a foster youth tracking system according to claim 12 wherein said external data sources comprise a plurality of governmental entity databases.

18. The method of collecting, storing, displaying, and updating foster youth data through a foster youth tracking system according to claim 12 wherein said second smart card utilizing step occurs prior to said first smart card utilizing step.
